(19) United States
(12) Patent Application Publication
(10) Pub. No.: US 2017/0085563 A1
(43) Pub. Date: Mar. 23, 2017

(54) SYSTEM FOR VALIDATING A BIOMETRIC INPUT

(71) Applicant: First Data Corporation, Greenwood Village, CO (US)

(72) Inventor: Vijay Kumar Royyuru, Norristown, PA (US)

(73) Assignee: First Data Corporation, Greenwood Village, CO (US)

(21) Appl. No.: 15/269,689

(22) Filed: Sep. 19, 2016

Related U.S. Application Data
(60) Provisional application No. 62/220,757, filed on Sep. 18, 2015.

(51) Int. Cl. H04L 29/06; G06Q 20/40; G06Q 30/02; H04L 9/32

(52) U.S. Cl. CPC H04L 63/0861; H04L 63/0853; H04L 63/166; H04L 9/3213; H04L 9/3231; H04L 63/10; G06Q 20/40145; G06Q 30/0277; H04L 2463/082

(57) ABSTRACT

A computing device for biometric authentication includes an input interface, a biometric input interface with a biometric sensor, a communications interface, a memory, and a processor. The processor navigates a browser to a website and receives an input associated with a biometric access icon associated with a secure webpage that is displayed on the website. The processor launches an interface of a mobile authentication application upon receiving the input. The interface includes an instruction to provide a biometric input. The processor receives the biometric input and compares the received input with a stored input. The stored input is stored on the memory. The processor authenticates a user of the computing device based on the comparison of the received input and the stored input, communicates an authentication confirmation to an entity associated with the secure webpage, and receives a uniform resource locator (URL) associated with the secure webpage.

### CROSS-REFERENCES TO RELATED APPLICATIONS

This application claims priority to U.S. Provisional Patent Application No. 62/220,757 filed Sep. 18, 2015, entitled “SYSTEM FOR VALIDATING A BIOMETRIC INPUT,” the entire disclosure of which is hereby incorporated by reference, for all purposes, as if fully set forth herein.

### BACKGROUND OF THE INVENTION

Many websites utilize password-based single factor authentication for access to areas of the sites, such as registered user only sections and/or payment and check out sections. These passwords may be easily compromised. Additionally, when using a browser on a mobile device, inputting a password may create a poor user experience as the keyboards are often small, making it difficult for the user to type accurately. This also creates problems when entering checkout information, such as addresses and credit cards, while making purchases using a browser of a mobile device. Oftentimes, transaction websites require many clicks to move from data field to data field and page to page. Additionally, the use of payment cards on file may require enrollment, check in, and/or authentication steps that are difficult to perform using a mobile browser.

### BRIEF SUMMARY OF THE INVENTION

Embodiments of the invention provide systems and methods for enabling two-factor biometric authentication within mobile browsers. Such authentication improves the website log in process for users of mobile devices, and also enables streamlined one-click purchases from any website using the mobile browser. Two-factor authentication as described herein requires a Something-You-Have factor and a Something-You-Are factor. Here, the Something-You-Have factor is the user having a particular mobile device. The Something-You-Are factor is a biometric input associated with the user, such as a fingerprint. The use of two-factor authentication provides an extra layer of security beyond just a password, as a user having a particular biometric input must be in possession of a particular device rather than any person being able to use a password on any device.

In one aspect, a method for validating a biometric input on a mobile device is provided. The method may include storing a website URL and a user credential associated with the website URL on a memory of the mobile device. The method may also include navigating a browser of the mobile device to a website associated with the website URL. The website may request the user credential for access to a next page. The method may further include launching an interface of a mobile authentication application upon receiving a request to use the mobile authentication application. The interface may include an instruction to provide a biometric input. The method may include receiving the biometric input using a biometric sensor of the mobile device and comparing the received biometric input with a stored biometric input. The stored biometric input may be stored on the memory of the mobile device. The method may also include authenticating a user of the mobile device based on the comparison of the received biometric input and the stored biometric input. The method may further include retrieving the user credentials and providing the user credentials to the website's back end server such that the next page of the website is accessible to the user.

In another aspect, a computing device configured for biometric authentication is provided. The mobile device may include a touchscreen display, a biometric input interface including at least one biometric sensor, a communications interface, a memory, and a processor. The processor may be configured to navigate a browser of the computing device to a website and to receive, via the touchscreen display, an input associated with a biometric access icon displayed on the website. The biometric access icon may be associated with a secure webpage. The processor may also be configured to launch an interface of a mobile authentication application upon receiving the input. The interface may include an instruction to provide a biometric input. The processor may be further configured to receive the biometric input using the biometric input interface of the mobile device and to compare the received biometric input with a stored biometric input. The stored biometric input may be stored on the memory of the computing device. The processor may be configured to authenticate a user of the computing device based on the comparison of the received biometric input and the stored biometric input, to communicate, via the communications interface, an authentication confirmation to an entity associated with the secure webpage, and to receive, via the communications interface, a uniform resource locator (URL) associated with the secure webpage.

In another aspect a method for validating a biometric input on a user device is provided. The method may include providing software code to a website. The software code may cause an interactive biometric access icon to be displayed on devices accessing the website. The biometric access icon may be associated with a secure webpage. The method may also include receiving an input from a user device. The input may be indicative of an interaction with the interactive biometric access icon. The interaction may cause an initialization of a biometric authentication application to execute on the user device. The method may further include receiving an indication that a user of the user device was successfully authenticated using the biometric authentication application and retrieving user information associated with the authenticated user. The method may include sending an authorization request to an entity associated with the secure webpage. The authorization request may include the retrieved user information. The method may also include receiving an authorization confirmation. The authorization confirmation may include a uniform resource locator (URL) associated with the secure webpage.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a system diagram showing a system for validating biometric inputs according to embodiments.

FIG. 2 is a system diagram showing a system for validating biometric inputs according to embodiments.

FIG. 3A is a flow showing a process for successfully validating biometric inputs using a mobile browser according to embodiments.

FIG. 3B is a flow showing a process for a failed validation of a biometric input according to embodiments.

FIG. 3C is a flow showing a process for validating biometric inputs for a purchase within a banner advertisement according to embodiments.

FIG. 4 is a flowchart showing a process for validating biometric inputs according to embodiments.

FIG. 5 is a flowchart showing a process for validating biometric inputs according to embodiments.

FIG. 6 is a flowchart showing a process for validating biometric inputs according to embodiments.

FIG. 7 is a swimlane diagram of a process of enrolling a website in a biometric authentication system according to embodiments.

FIG. 8 is a swimlane diagram of a process of accessing a restricted webpage using biometric authentication according to embodiments.

FIG. 9 is a block diagram of an example computing system according to embodiments.

### DETAILED DESCRIPTION OF THE INVENTION

While biometric authentication is used to login to the mobile device, for use in mobile applications, and for completing mobile transactions using mobile applications, there is no such ability to utilize biometric inputs through mobile browsers of mobile devices. Systems and methods herein provide biometric authentication techniques that leverage existing biometric mobile applications, such as by interfacing with the application programming interface (api) of the biometric mobile application and websites, to authenticate uses of mobile device browsers. This may done using software development kits (SDK), mobile applications, and the like to interface with existing software and hardware systems of a mobile device and any servers, such as those hosting the websites. The techniques described herein reduce and/or eliminate the need to continually enter information into a browser using a mobile device keyboard and/or navigating data fields using a touchscreen or other input interface, such as a keyboard or mouse. It will be appreciated that the terms mobile device, user device, and computing device are used interchangeably herein. Such devices may include, without limitation, mobile phones, tablet computers, laptop computers, desktop computers, and/or other computing devices that are configurable, either on their own or with connectable equipment, to perform biometric authentication.

Additionally, embodiments of the invention provide systems and methods for enabling two-factor biometric authentication within mobile browsers. Such authentication improves the website login process for users of mobile devices, and also enables streamlined one-click purchasing from any website using the mobile browser. For example, upon reaching a login screen, a user may provide a biometric input to the mobile device for authentication. The mobile device may authenticate the user and provide previously stored user credentials to a backend server associated with the log-in screen. Similarly, upon checking out at a mobile commerce webpage, a user may provide a biometric input, which may trigger the provision of checkout information to be provided to a backend server associated with the mobile commerce webpage. Thus, the user is able to login and/or checkout without entering passwords and/or other information using a keyboard of the mobile device. Embodiments described herein utilize the possession of a particular mobile device as the Something-You-Have factor and the user's biometric input as the Something-You-Are factor. Biometric inputs may include fingerprints, retinal scans, voice samples, 3-dimensional facial recognition, and the like.

Embodiments may leverage preexisting software, such as a biometric mobile application provided by a manufacturer of the mobile device, to authenticate a user's fingerprint and/or other biometric input. Mobile applications include software programs that are installable on data-ready devices and are executable by a user interaction with an icon (e.g., a user touching an icon on a touchscreen of a wireless device or a display of the wireless device. Mobile applications often enable limited and specific functionality to wireless devices when executed. In some embodiments, payment transactions may be completed by leverage existing payment networks, such as automated teller machine (ATM) networks. This allows for a single issuer to enroll users within a biometric payment system that may be used on any website that accepts payments through the ATM network. In such a manner, a user may need only enroll in the system a single time (which may be done by the issuer rather than the user) and the user will have access to the biometric payment system on any website.

As one example, a user may enroll a fingerprint in the preexisting biometric mobile application. The user may then enroll a website for use in mobile authentication. For example, the user may enter a website URL and/or corresponding user credentials into and stored by a mobile authentication application that makes use of the preexisting mobile application. When a user wishes to access a restricted page (or other page requiring user credentials) of a website, the biometric mobile application may be launched such that it prompts the user to provide a biometric input. For example, the launching of a website may trigger the mobile authentication application to open the biometric mobile application to the prompt screen. The biometric input is then authenticated by the biometric mobile application, and the user credentials are provided to the website. Such two-factor biometric authentication provides a further layer of security for accessing websites using a browser, as fraudsters cannot merely acquire, guess, and/or hack a user's password, but also must get a user's device and biometric signature to access secured webpages.

In some embodiments, rather than using a preexisting mobile application, the mobile authentication application may include the ability to store, receive, compare, and/or authenticate biometric inputs using the processing power and/or biometric sensors of the mobile device. It will be appreciated that when referring to the mobile authentication application, embodiments using both a mobile authentication leveraging an existing biometric mobile application and embodiments using only the mobile authentication application are considered. Thus, reference made herein to launching an interface of the mobile application may refer to the mobile authentication application detecting a website URL matches a website URL enrolled for use with the mobile authentication application and launching an interface of a preexisting biometric mobile application, as well as reference to the mobile authentication application launching its own interface upon detection of a matching website URL. Additionally, an enrolled website may provide a Touch In and/or Touch Buy button with which a user may interact to cause an input interface of the biometric mobile application to launch.

In some embodiments, a user and any associated payment accounts may be enrolled in the biometric access systems by an issuer of the payment accounts. In such embodiments, a biometric access icon may be automatically displayed when the user accesses webpages that support the biometric browser payments. In other embodiments, each user may actively enroll one or more websites in a biometric access system. This may include providing login credentials, user information, billing information, payment information, shipping information, and/or other information for one or more websites. Each enrolled website may then display a biometric access icon that may be used to access the system. Each user may be able to set up rules for account selection, loyalty burn, offer selection, based on merchant and transaction context. Additionally, enrollment may enable other digital presence (such as banner ads) to be enabled with biometric access icons. This allows user to shop and checkout at a website merely by clicking on a biometric access icon displayed within a banner ad.

To use the biometric payment system, the user may click or otherwise interact with a biometric access icon on a webpage, banner ad, or other area of a display to complete a purchase. The user will be prompted to provide a biometric input that, once authenticated, will allow the mobile device to provide any necessary details associated with the transaction to the entity that will fulfill the terms of the purchase. With such systems, users may earn loyalty rewards and/or spend benefits of loyalty programs. Users may also receive targeted and relevant offers that are redeemable merely by interacting with a biometric access icon. In some embodiments, the user may be able to split tender between gift and ATM or other payment accounts. In addition to making the transactions simpler and more efficient for the end user, the use of two-factor biometric authentication helps reduce the prevalence of fraud for the issuer of the payment accounts.

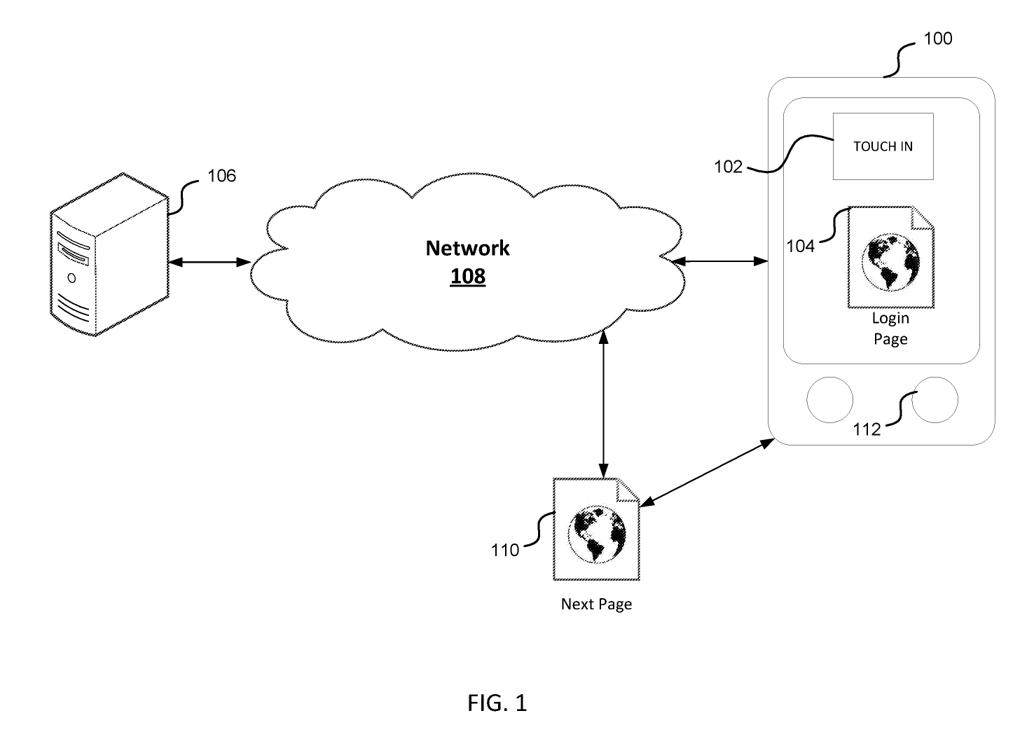

Turning now to FIG. 1, a system for validating a biometric input on a mobile device 100 is shown. A mobile device 100 may include mobile phones, tablet computers, laptop computers, and other wireless communications devices that include mobile browsers and one or more biometric sensors 112. Biometric sensors 112 may include fingerprint sensors, microphones for receiving audio inputs such as a voice sample, retinal scanners, cameras and software configured for facial recognition and/or retinal scanning, and and/or other biometric sensors. Here, mobile device 100 is shown with a browser of the mobile device 100 open to a login page 104. The user may enroll the login page 104 into a mobile authentication application, such as by entering a website URL for the login page 104 and corresponding user credentials into the mobile authentication application. For enrollment, the corresponding user credentials may be identified by retrieving and/or identifying user credential data fields from a backend server 106 that hosts and/or is otherwise associated with the website. The user credentials may include a user identifier, password, token, and/or other user-related information. Mobile device 100 may communicate with website and/or backend server 106 associated with the website over a network 108.

Network 108 may be a local area network (LAN) and/or other private or public wired and/or wireless networks. Network 108 may utilize one or more of Wi-Fi, ZigBee, Bluetooth™ Bluetooth™ Low Energy, a cellular communications protocol such as 3G, 4G, or LTE, and/or any other wireless communications protocol. Network 108 may be communicatively coupled with one or more of the components of the system to facilitate communication between the various components. It will be appreciated that one or more different network connections may be used in accordance with the invention, and that the use of a single network 108 to enable communications is merely one example of such configurations. For example, each component may be communicatively coupled with other components using a separate network for one or more of the connections.

The enrollment may be done by a user opening an interface of the mobile authentication application on the mobile device 100 and/or by clicking an enrollment button provided by the browser and/or the login page 104. The enrollment may be done for a first time user of the website, by preexisting users that wish to convert to a biometric authentication, and/or to include a biometric authentication as a backup authentication to entering a password.

Upon enrolling the login page 104, the mobile authentication application may leverage an existing biometric mobile application to receive and locally authenticate a biometric input based on a stored biometric input stored on the mobile device 100. As noted above, it will be appreciated that in some embodiments, the functions performed by the existing biometric mobile application may be performed by the mobile authentication application. As one example, upon navigating the browser to the login page 104, a Touch In button 102 may be displayed. The Touch In button 102 may be on a ribbon ad, the login page 104, and/or other area of the browser. Upon the user interacting with the Touch In button 102, the mobile authentication application may leverage the biometric mobile application to perform an authentication of the user. For example, Touch In button 102 may include a “deep link” that opens the mobile authentication application and/or other biometric mobile application to a specific location or interface of the mobile application. Specifically, an interface for receiving a biometric input and/or for instructing a user to provide a biometric input may be opened upon the user interacting with the Touch In button 102.

Upon successful authentication, the mobile authentication application retrieves the user credentials using a token service provider (TSP). In some embodiments, the TSP may be a separate server or computing device, while in other embodiments, the TSP may be part of backend server 106. The TSP may generate tokens that take the place of payment media identifiers and/or other account identifiers. The TSP may also store the token and its corresponding account identifier, as well as perform other transactional services with the token, according to EMVco tokenization standards. The user credentials may be stored on the mobile device 100 and/or a remote server or network attached storage. The user credentials are then provided to the server 106, which is associated with the website. Along with the user credentials, a website URL for the website on the browser, a secure page or next page URL, and/or other information may be retrieved and provided to the server. Server 106 may then provide a next page 110 of the website to the browser and/or otherwise direct the browser to navigate to the next page 110 of the website, such as a registered user access only section. This communication between the mobile authentication application and the backend server 106 is done with mutual authentication: the mobile application authenticates the backend server 106 using transport layer security (TLS), while the backend server 106 authenticates the mobile authentication application and trusts the user authentication assertion being made by the mobile authentication application by validating the signature in that message that was generated by the mobile application using a private key.

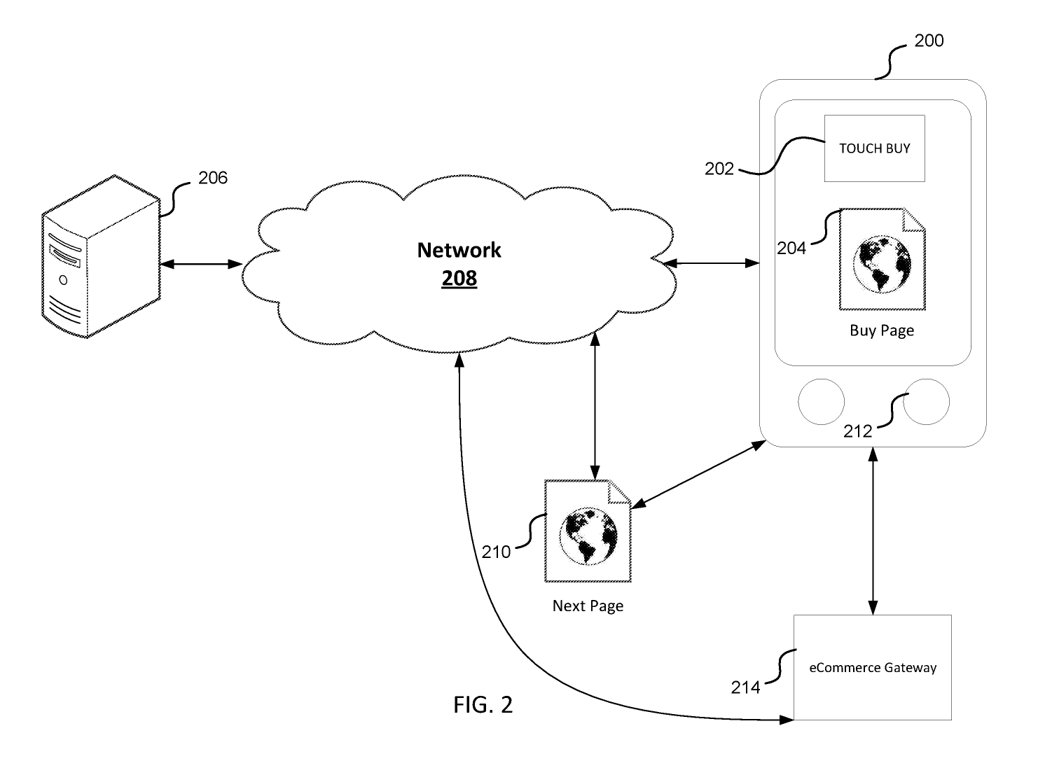

FIG. 2 depicts a system for validating a biometric input for use in mobile transactions using a mobile device 200. The system of FIG. 2 is similar to that shown in FIG. 1. For example, Mobile device 200 may include one or more biometric sensors 212. Here, mobile device 200 is shown with a browser of the mobile device 200 open to a buy page 204. A buy page 204 may include virtual shopping carts and other checkout pages. Oftentimes, a great deal of user and/or transaction information must be provided on buy page 204. Entering this information may require clicking on and entering data into many different data fields using the small keyboard of the mobile device 200. As such, the user may wish to utilize a Touch Buy solution when using the buy page 204. Mobile device 200 may communicate with website and/or backend server 206 associated with the website over a network 208, which may be similar to network 108 described above.

The mobile authentication application may leverage an existing biometric mobile application to receive and locally authenticate a biometric input based on a stored biometric input stored on the mobile device 200. As noted above, it will be appreciated that in some embodiments, the functions performed by the existing biometric mobile application may be performed by the mobile authentication application. As one example, upon navigating the browser to the buy page 204, a Touch Buy button 202 may be displayed. Touch Buy button 202 may have a transaction and/or item identifier built in. This allows the particular item, transaction, and/or amount to be referenced in the authentication process of the user and in the processing of transaction data provided within the user credentials submitted to the website and/or server 206. The Touch Buy button 202 may be on a ribbon ad, the login page 204, next to and/or combined with an icon or other button for purchasing a good or service, and/or other area of the browser. Upon the user interacting with the Touch Buy button 202, the mobile authentication application may leverage the biometric mobile application to perform an authentication of the user. For example, Touch Buy button 202 may include a “deep link” that causes the browser to open the mobile authentication application and/or other biometric mobile application to an inner page or other specific location or interface of the mobile application. Specifically, an interface for receiving a biometric input and/or for instructing a user to provide a biometric input may be opened upon the user interacting with the Touch Buy button 202 without loading a startup page of the mobile application.

Upon successful authentication, the mobile authentication application retrieves the user credentials using a TSP, which may be part of server 206 and/or a separate entity. The user credentials may include the transaction data, such as price and/or product information, which may be stored on the mobile device 200 and/or a remote server. For example, in some embodiments, the transaction data may be stored in a mobile wallet application and/or other application or memory of the mobile device. In some embodiments, upon successful local biometric authentication, a cryptogram is computed by the mobile device 200. The mobile device 200 may use a device key issued by a backend server, such as sever 206 to generate a cryptogram upon authentication, as well as form a payment data payload for authorization. The mobile device 200 may then provide the payment data payload to an ecommerce gateway 214 for authorization, upon which the ecommerce gateway 214 may route the transaction to the payment network, such as an ATM network. The payment network may use the TSP and another server (such as server 206) to de-tokenize and validate the cryptogram, thereby establishing a strong multi-factor authentication process. The issuer may then authorize the strongly authenticated transaction.

The user credentials are then provided to server 206, which is associated with the website. The server 206 may then provide a next page 210 of the website to the browser and/or otherwise direct the browser to navigate to a next page 210 of the website. Next page 210 may be an order confirmation page and/or a second page of the checkout process. For example, the checkout process may include entry of several pages of information. For example, a first page may include shipping information while a second page includes payment information. User credentials corresponding to data fields on each page may be enrolled, stored, retrieved, and/or provided accordingly, such that upon commencing the purchase process, the user only needs to biometrically authenticate a single time to have all of the necessary user credentials provided to the website for completion of the purchase. This communication between the mobile authentication application and the backend server 206 is done with mutual authentication: the mobile application authenticates the backend server 206 using transport layer security (TLS), while the backend server 206 authenticates the mobile authentication application and trusts the user authentication assertion being made by the mobile authentication application by validating the signature in that message that was generated by the mobile application using a private key.

In some embodiments, the mobile authentication application and/or mobile device 200 may communicate with an ecommerce gateway 214, which may be a secure server of a financial institution that may authorize an ecommerce payment. Upon authentication of the user, payment and/or other transaction data may be communicated to the ecommerce gateway 214 for approval of the transaction, such as by authorizing a payment using a payment media stored with the user credentials. The approval may then be communicated to the website and/or server 206 for completion of the transaction and authorization to proceed to the next page 210.

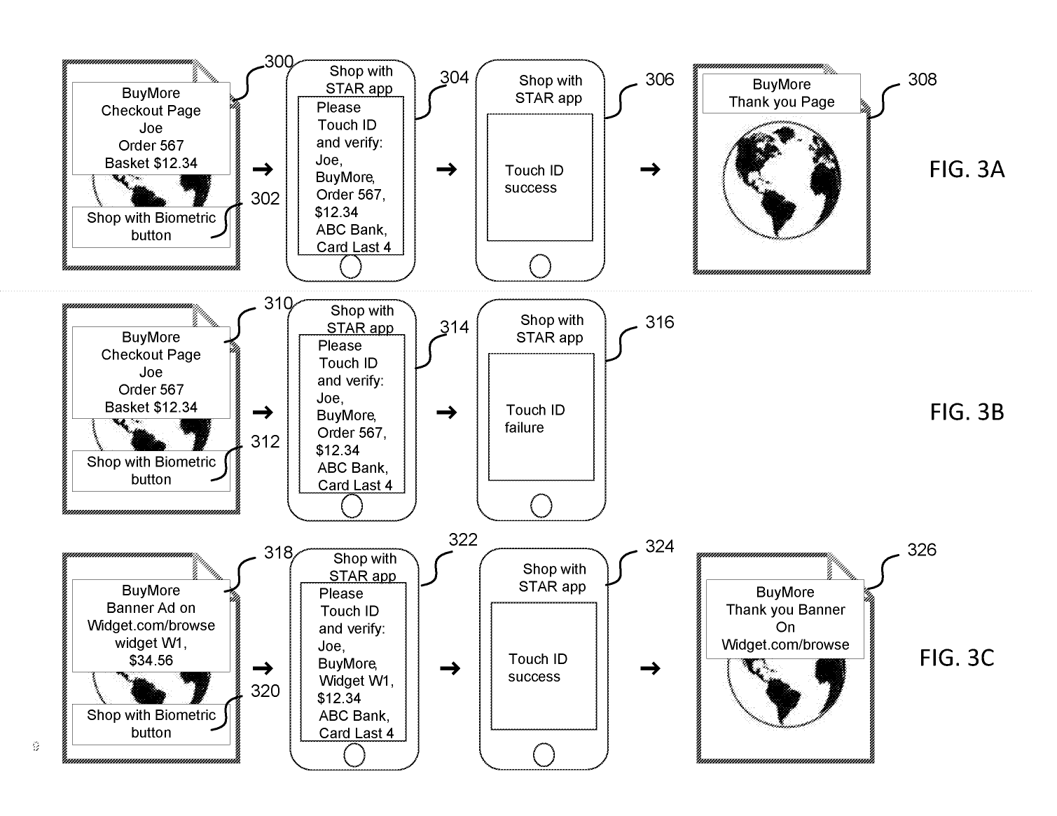

FIGS. 3A-3C depict flows showing user interactions for biometric authentication using a mobile device. In FIG. 3A, a user accesses a checkout page 300. Here, the checkout page includes order information, such as an order number, products and/or services to be purchased, a purchase price, and/or other information. Checkout page 300 may include a biometric access icon 302 associated with the checkout page. The user may interact with the biometric access icon 302, such as by touching the icon on a touchscreen display of the mobile device. Upon interacting with the biometric access icon 302, a biometric authentication application 304 may be launched on the mobile device as described herein. The biometric authentication application may prompt the user to provide a biometric input, such as a fingerprint. This input may be authenticated locally using the mobile device and the biometric authentication application. In some embodiments, during the authentication process, the user may be asked to confirm the purchase details. In some embodiments, such a confirmation may occur as the user is prompted for the biometric input. For example, the purchase details may be listed on the screen of the mobile device, along with a prompt asking for the biometric input if the purchase details shown on the screen are correct. Upon successful authentication, a confirmation of success 306 may be provided to the user of the mobile device. A URL associated with a secure page 308, such as a purchase confirmation page may then be retrieved and displayed on the mobile device. Upon successful authentication, the user's information, such as payment information, shipping information, other identity information, as well as the purchase details may be forwarded to the entity fulfilling the payment transaction, thus eliminating the need for the user to input such information on their own.

In FIG. 3B, a failed authentication attempt is depicted. Similar to FIG. 3A, a user accesses a checkout page 310. Checkout page 310 may also include a biometric access icon 312 associated with the checkout page. Upon interacting with the biometric access icon 312, a biometric authentication application 314 may be launched on the mobile device. The biometric authentication application may prompt the user to provide a biometric input, such as a fingerprint. This input may be authenticated locally using the mobile device and the biometric authentication application. Here, the authentication was unsuccessful due to a mismatch between the received biometric input and a stored biometric input. A failure message 316 is returned to the user. In some embodiments, the user may be prompted to provide another biometric input to attempt authentication again. In other embodiments, a failed authentication may result in the user being sent back to the checkout page where they can complete the transaction in a traditional manner, entering in payment and shipment details by hand. The user may also interact with the biometric access icon 312 a second time to begin the biometric authentication process again.

FIG. 3C depicts a biometric authentication associated with a purchase of a good or service from an entity other than one operating a website that is being viewed on the mobile device. For example, the mobile device may be accessing a website 318 for widget.com. A banner advertisement affiliated with another source (here BuyMore) may be presented on the website 318. A biometric access icon 320 may be included within the banner advertisement that allows a user to purchase a product and/or service associated with the banner advertisement from the another source, without the user needing to visit a new webpage. For example, the user may touch the biometric access icon 320 within the banner advertisement and be presented with a screen of a biometric authentication application 322, which has been launched on the mobile device. The biometric authentication application may prompt the user to provide a biometric input to confirm the purchase details, which may be presented on the display of the mobile device. Upon successful authentication, a confirmation of success 324 may be provided to the user of the mobile device and the user's information, such as payment information, shipping information, other identity information, as well as the purchase details may be forwarded to the entity fulfilling the payment transaction, thus eliminating the need for the user to input such information on their own. The mobile device may then return to displaying the website 318, which now has an order confirmation 326 displayed in the banner advertisement. In such a manner, the user is able to complete a purchase without visiting a website associated with the source of the purchase (BuyMore) and may instead resume his browsing on widget.com without needing to navigate between multiple webpages.

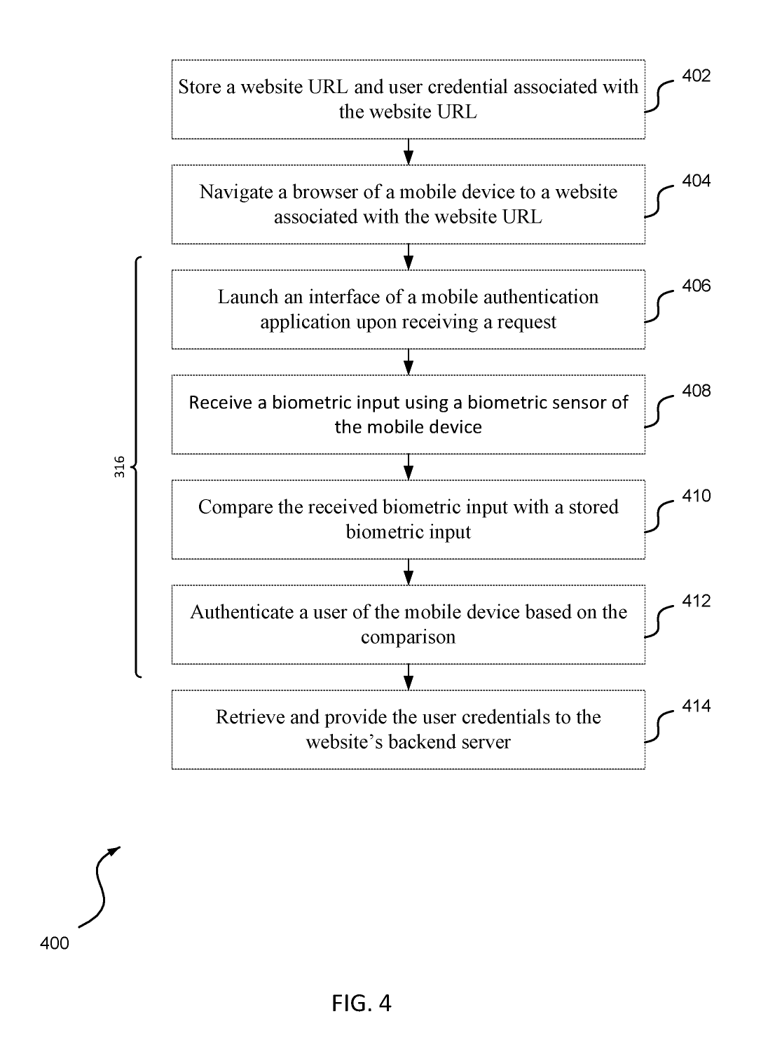

FIG. 4 depicts a flowchart of one embodiment of a process 400 for validating a biometric input on a mobile device. Process 400 may be performed by a mobile device, such as a mobile device executing a mobile application. Process 400 may begin with storing a website URL and a user credential associated with the website URL on a memory of the mobile device at block 402. This may be done by registering a website for use with a mobile authentication application. A user may enroll a website by clicking a link on the website prompting an enrollment process and/or a user may use an interface of the mobile authentication application to enroll a website. The user may enter a website URL into the mobile device and the mobile device may retrieve the necessary data fields from the website and/or from a server hosting the website for user credentials requested for the website. In some embodiments, the user may then be prompted to enter the corresponding user credentials, such as a username and password, into the mobile device. In other embodiments, the mobile authentication application may obtain the user credentials from a backend server associated with the website. The user credentials are linked to the website URL and this information is stored in a memory of the mobile device. In some embodiments, the user credentials may be stored in a portion of the memory and/or associated with a storage application that enables the user credentials to be utilized with any application executed on the mobile device. In other embodiments, the user credentials may be stored in a portion of the memory and/or associated with a storage application that provides only application-specific access. In other words, only the mobile authentication application may utilize the stored user credentials, and the stored user credentials may be limited to use within a mobile browser.

A user may enroll multiple websites for use with the mobile authentication application, with each website being able to request its own set of user credentials used to authenticate the user. For example, the website may restrict access to registered users, requiring users to log in on a first page, or login screen, prior to accessing the main website. In such embodiments, the required user credentials may include a username, a password, and/or other information that may be used to identify the user. In other embodiments, the website may be a check out site of a mobile commerce website, and the next page may be a purchase confirmation page and/or an additional checkout page. In such embodiments, the user credentials may include a username, a password, and/or transaction information. This transaction information may include any information that may be needed to conduct a transaction using the mobile browser. For example, the transaction information may include a name of a recipient, the recipient's address, a preferred shipping method, payment information, such as a credit card number or other payment media identifier, a billing address, a name of the holder of a payment account associated with the payment media and the like

In some embodiments, the website and/or user credential may be stored at a cloud server or other remote storage device in addition to, and/or alternatively to the memory of the mobile device. Such data may be indexed and associated with a particular user and/or mobile device for quick retrieval when needed. By storing some or all of this data at a remote server, storage space of the mobile device's memory can be preserved.

After enrollment, a browser of the mobile device may be navigated to a website associated with the website URL at block 404. For example, a user may enter the website URL into a navigation field of the mobile browser and/or a user may click a link, such as a link in an email, SMS message, and/or other website to instruct the mobile browser to navigate to the desired website. The website may request the user credential for access to a next page. For example, login pages may request a username, a password, and/or other information that may be used to identify the user and checkout pages may request a username, a password, and/or transaction information.

An interface of a mobile authentication application may be launched upon receiving a request to use the mobile authentication application at block 406. The request may be received based on a user input. For example, the user may click a Touch In or Touch Buy button, such as those shown in FIGS. 1 and 2. These buttons may be integrated into specific websites, contained in banner ads, provided by the mobile browser when the browser detects one or more user credential data fields on a website, and/or in other locations. In other embodiments, the mobile browser may be tied into the mobile authentication application such that when navigated to a website URL matching one stored in the mobile authentication application, the interface is launched. Thus, the request is automatically triggered upon matching the website URL to one stored in the mobile authentication application. The interface may include an instruction to provide a biometric input. In some embodiments, the interface may only provide a textual and/or image instructing the user to supply the biometric input, such as by placing the user's finger over a fingerprint sensor, positioning the user's face and/or eye near a camera or other retinal/facial scanner, and/or providing a voice sample into a microphone of the mobile device.

The biometric input may be received using a biometric sensor of the mobile device at block 408. This may include the user providing a fingerprint, retinal scan, facial scan, voice sample, and/or other biometric identifier to a sensor of the mobile device. At block 410, the received biometric input may be compared with a stored biometric input. The stored biometric input may be stored on the memory of the mobile device. This stored biometric input is often set up prior to enrolling a website for use with the mobile authentication application. For example, a user may register a fingerprint and/or other biometric input for use in logging into the mobile device and/or for use with other mobile applications. A user of the mobile device may be authenticated based on the comparison of the received biometric input and the stored biometric input at block 412. In some embodiments, the received biometric input may be received, compared, and authenticated by leveraging a preexisting application or other software program configured to handle biometric authentication. For example, a mobile device may include a biometric authentication application provided and/or installed by the manufacturer and/or service provider of the mobile device. The mobile authentication application may utilize this biometric authentication application to complete the authentication process. In some embodiments, this application may serve as the mobile authentication application, with the user being able to enroll websites on a mobile browser for use with the application.

Upon authentication, at block 414, the user credentials may be retrieved and provided to the backend server associated with the website such that the next page of the website is accessible to the user. For example, after the received biometric input is matched with the stored biometric input, the user credentials matching the website URL may be retrieved from the memory of the mobile device and/or from a remote storage location. Upon receiving the user credentials, the server may provide the next page to the mobile device and/or browser, and/or the server may otherwise provide access to a registered users only section and/or a next page of a checkout process, such as a confirmation page. In some embodiments, a device identifier of the mobile device may be passed to the website and/or server in addition to the user credentials. This may be done prior to, after, and/or concurrently with sending the user credentials. The website and/or server may then perform mutual authentication to verify the user and/or mobile device identities to help avoid spoofing and man in the middle MIM scams. The data sent between the mobile device and website and/or server may be encrypted for further protection. This communication between the mobile authentication application and the backend server may be done with mutual authentication: the mobile application authenticates the backend server using transport layer security (TLS), while the backend server authenticates the mobile authentication application and trusts the user authentication assertion being made by the mobile authentication application by validating a signature in that message that was generated by the mobile application using a private key. The server may then provide a single-use authorization code to the mobile authentication application, which may be passed to the browser. The browser may then provide the authorization code to the server to receive a URL for the next page.

In some embodiments, blocks 406-412, which are shown in bracket 416, may be performed by a separate mobile application. For example, a mobile device may include a biometric mobile application installed or otherwise provided by a manufacturer and/or service provider of the mobile device. The mobile authentication application may detect that a browser is at a website URL matching one enrolled for use with the mobile authentication application. The mobile authentication application may then cause the biometric mobile application to launch to perform a local authentication of the user's biometric input. Upon the biometric mobile application successfully authenticating the user, the mobile authentication application may cause the user credentials to be provided to the website.

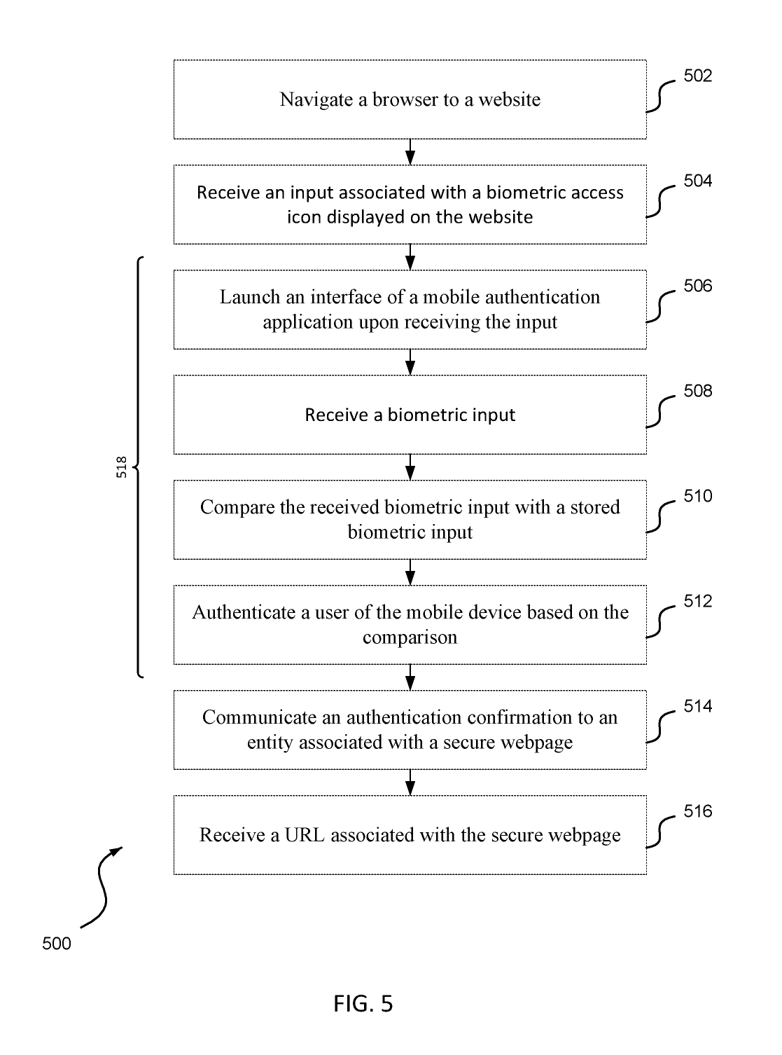

FIG. 5 depicts a flowchart of a process 500 for biometric authentication within a mobile browser is provided. Process 500 may be performed by a processor of a mobile device, such as a cellular phone, tablet computer, laptop computer, and/or other user or computing device that includes a biometric reader (such as a camera, fingerprint reader, retinal scanner, microphone, etc.) configured for biometric authentication. Process 500 may begin by navigating a browser of the mobile device to a website at block 502. At block 504 the mobile device may receive, via the touchscreen display or other input interface, such as a keyboard or mouse, an input associated with a biometric access icon displayed on the website. The biometric access icon may be associated with a secure webpage. In some embodiments, the secure webpage may be a webpage that includes information specific to a particular user, such as account details, content available by subscription only, and the like. In other embodiments, the secure webpage may be associated with a checkout page for a particular purchase transaction. For example, a user may select one or more items to place in a web cart. The website may provide a biometric access icon that provides one-click, biometrically authenticated purchases. The biometric access icon may be associated with the particular website being displayed and/or may be associated with another website, such as one advertised within a banner ad or provided using a hyperlink. In some embodiments, the mobile device and/or user must be enrolled for use with the biometric access icon and/or biometric access/payment system. This may be done as described above, either by the user or by an issuer of a payment account. For example, enrolling the user may include displaying a prompt for user information associated with the secure webpage, receiving user information at the mobile device, and sending the user information to a network storage device using a token service provider (TSP).

At block 506, an interface of a mobile authentication application may be launched upon receiving the input. The interface may include an instruction to provide a biometric input, such as a fingerprint, voice sample, retinal scan, or the like. In embodiments where the secure webpage is associated with a purchase transaction, the instruction to provide the input may also include a confirmation of purchase terms that are to be reviewed by the user prior to providing the biometric input. The biometric input may be received using the biometric input interface of the mobile device at block 508 and compared with a biometric input stored on the mobile device at block 510. The user of the mobile device is then authenticated based on the comparison of the received biometric input and the stored biometric input at block 512. An authentication confirmation is then communicated to an entity associated with the secure webpage, such as an entity to fulfill a purchase transaction or a source of other secured information, at block 514.

In some embodiments, this consists communicating the authentication confirmation to a backend server that routes the authentication confirmation to the entity. The process 500 may further include authenticating the backend server using transport layer security (TLS) while the backend server authenticates the mobile authentication application such that the backend server trusts the authentication of the user by the mobile authentication application. The mobile device may then receive a single-use authorization code from the backend server and provide the single-use authorization code to the browser for provision to the backend server. The URL associated with the secure webpage may then be received in response to the provision of the single-use authentication code to the backend server. In some embodiments, process 500 includes generating a cryptogram using the mobile authentication application upon successfully authenticating the user and providing the cryptogram to a backend server. The cryptogram is validated by the backend server and/or entity associated with the secure webpage as part of a multi-factor authentication process.

In other embodiments, communicating the authentication confirmation to an entity includes providing a browser identifier and a token to a backend server. Process 500 may also include receiving, using the mobile authentication application, an encrypted authorization code and an encrypted access URL from the backend server. The encrypted authorization code and the encrypted access URL may be decrypted by the mobile authentication application using a private key. The decrypted authorization code and the decrypted access URL are provided to the browser, which may send an authorization request to access the secure webpage. In some embodiments, the authorization request may include the decrypted authorization code and the decrypted access URL. The browser may then receive an access token from the backend server. The access token may be generated by the backend server in response to validating the decrypted authorization code. The URL associated with the secure webpage is then received by the browser. In some embodiments, the browser sends the access token to the backend server, and in response, receives an authorization message that provides the browser access to the secure webpage. The browser then navigates to the secure webpage.

At block 516, a uniform resource locator (URL) associated with the secure webpage is received by the mobile device for use by the browser. In embodiments where the secure page is a checkout page or confirmation associated with the completion of a purchase transaction, process 500 may also include upon successful authentication, communicate transaction information associated with the purchase transaction to the entity associated with the secure webpage. This may include payment details, shipping/billing addresses, user identification information, order/product details, and the like.

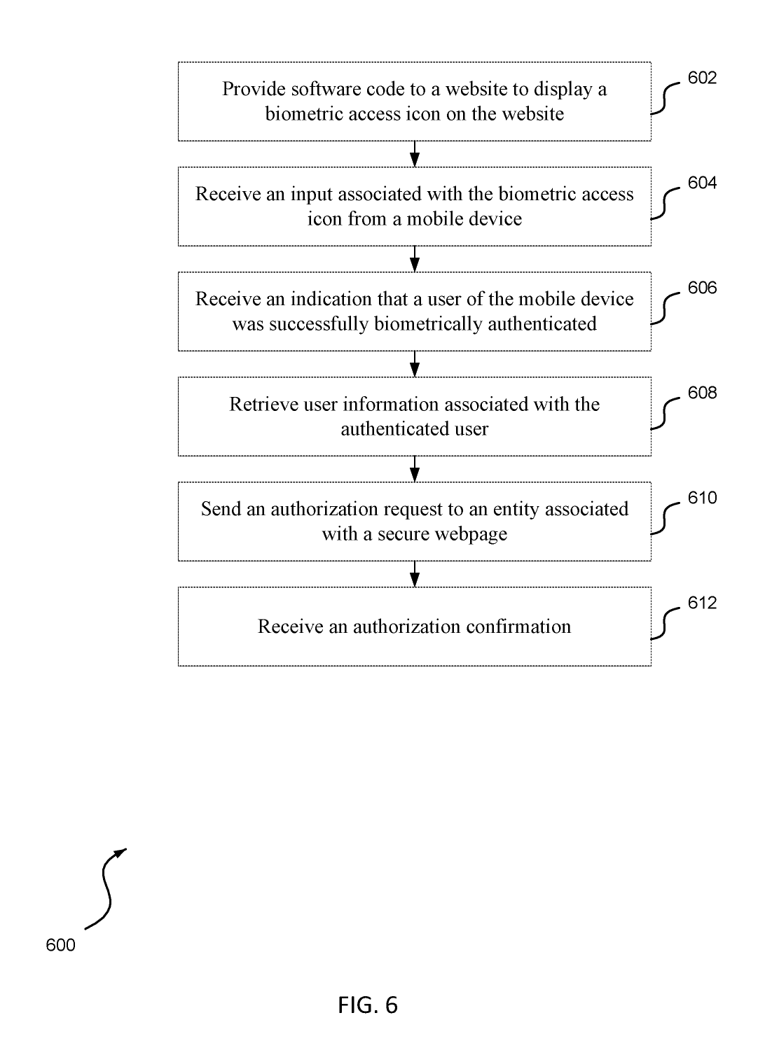

FIG. 6 depicts a flowchart of a process 600 for validating a biometric input on a mobile device is provided. Process 600 may be performed by one or more computing devices, such as backend server 106 and/or server 206. Process 600 may begin by providing software code to a website at block 602. The software code may cause an interactive biometric access icon to be displayed on devices accessing the website. The biometric access icon may be associated with a secure webpage. For example, the biometric access icon may be presented on a login screen of a website before a user is able to access secured information. In other embodiments, the biometric access icon may be associated with a checkout page or checkout confirmation page associated with the purchase of a good and/or service. In some embodiments, the biometric access icon may be embedded within a banner advertisement or other area of a website outside a login area. In some embodiments, process 600 also includes enrolling a user and/or mobile device for use with the biometric access icon. This may include prompting the mobile device for user information associated with the secure webpage, receiving the user information from the mobile device, and routing the user information and the URL associated with the secure webpage to a network storage device using a token service provider (TSP).

At block 604, an input is received from a mobile device, user device, and/or other computing device. The input may be indicative of an interaction with the interactive biometric access icon. For example, a user of the mobile device may have clicked, touched, or otherwise interacted with the biometric access icon on the mobile device. The interaction may cause an initialization of a biometric mobile authentication application to execute on the mobile device. An indication that a user of the mobile device was successfully authenticated using the biometric authentication application may be received at block 606. In some embodiments, receiving the indication that the user of the mobile device was successfully authenticated includes receiving a browser identifier associated with the interactive biometric access icon and a token from the mobile device. Process 600 may further include validating the browser identifier and the token, retrieving a public key upon validating the browser identifier and the token, and generating an authorization code and an access URL. The authorization code and the access URL may be encrypted using the public key. The encrypted authorization code and the encrypted access URL may be communicated to the biometric authentication application, which may be configured to decrypt the encrypted authorization code and the encrypted access URL using a private key. The biometric authentication application may provide the decrypted authorization code and the decrypted access URL to a browser of the mobile device. An authorization request is received from the browser to access the secure webpage. The authorization request includes the decrypted authorization code and the decrypted access URL. The decrypted authorization code and the decrypted access URL are validated and an access token is generated. The URL associated with the secure webpage is retrieved in response to successfully validating the decrypted authorization code and the decrypted access URL. The access token and the URL associated with the secure webpage are provided to the browser. The access token and the URL associated with the secure webpage are later received from the browser. The access token is authenticated and the browser is authorized to access the URL associated with the secure webpage.

At block 608, user information associated with the authenticated user may be retrieved. In some embodiments, the information may be retrieved from the mobile device. For example, the user information may be received along with or after the indication of successful authentication. In other embodiments, user information may be retrieved from a network attached storage device accessible by a server.

In some embodiments, process 600 includes issuing a token to the mobile device using a token service provider (TSP) and receiving a cryptogram upon receiving the indication that a user of the mobile device was successfully authenticated. The cryptogram may be generated by a token generator on the mobile device. Process 600 may further include de-tokenizing the cryptogram using a token service provider (TSP) and validating the de-tokenized cryptogram using the TSP. The authorization confirmation may include an indication that the de-tokenized cryptogram was successfully validated.

At block 610, an authorization request is sent to an entity associated with the secure webpage. The authorization request may include the retrieved user information. An authorization confirmation may be received from the entity at block 612. The authorization confirmation may include a uniform resource locator (URL) associated with the secure webpage. This URL may then be provided to the mobile device such that the mobile device may access the secure webpage using a browser.

In some embodiments, process 600 includes authenticating the biometric authentication application using transport layer security (TLS), communicating a single-use authorization code to the mobile device, receiving the single-use authorization code from a browser of the mobile device, and providing the URL associated with the secure webpage to the browser in response to receiving the single-use authentication code from the browser.

In embodiments where the secure webpage is a checkout page or checkout confirmation page, process 600 may also include receiving transaction information associated with the purchase transaction and communicating the transaction information to the entity associated with the secure webpage. The entity can then fulfill the order and process the payment. In some embodiments, the interactive biometric access icon is embedded within a banner advertisement displayed on the website. For example, a user may interact with the biometric access icon in a banner ad to purchase a product or service directly from the banner advertisement without visiting a website associated with the banner advertisement. Upon successful authentication and payment, the banner ad may be updated with a confirmation message related to the purchase transaction.

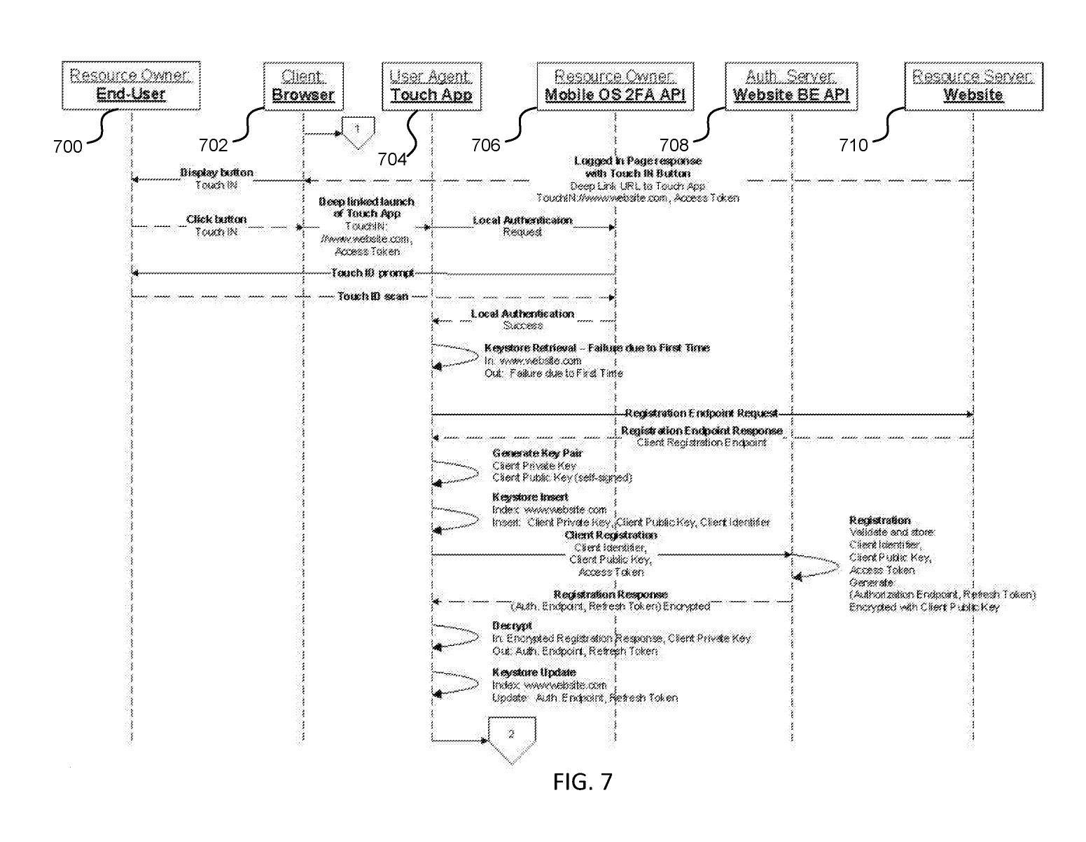

FIG. 7 is a swimlane diagram of a process for converting an existing user 700 of a website to a biometric access system. For example, a browser 702 may be directed to a website hosted by a resource server 710. Resource server 710 may present a logged in page of the website to the browser 702 upon the user 700 logging into the website using his existing user credentials, such as a user name and/or password. The logged in page includes a Touch In enrollment button that may be displayed to the user 700 on a display of a mobile device. This Touch In enrollment button may include a “deep link” that includes the URL of the website and an access token, which may be provided to the browser 702. The user 700 may then click the Touch In enrollment button, which may launch a mobile authentication application 704 of the mobile device using the “deep link.” The access token may also be provided to the mobile authentication application 704.

The mobile authentication application 704 may send an authentication request to a preexisting biometric mobile application 706 to perform a local authentication of the user 700. Biometric mobile application 706 prompts the user 700 to provide a biometric input, which is scanned and compared against a stored biometric input by the biometric mobile application 706. The biometric mobile application 706 may successfully authenticate the user 700 and provide an indication of the successful authentication to the mobile authentication application 704. The mobile authentication application 704 may then request registration with the resource server 710, which may provide a response to the mobile authentication application 704.

The mobile authentication application 704 may generate both a private and public key, which may be stored on the mobile device and associated with the website URL and an identifier associated with the browser 702 for future access only by the mobile authentication application 704. The mobile authentication application 704 may register or authenticate the browser 702 with an authorization server 708 associated with the website and/or resource server 710. This registration may include providing the browser identifier, public key, and the access token to the authorization server 708. The authorization server 708 may validate and store the browser identifier, the public key, and/or the access token. The authorization server 708 may also generate an authorization endpoint and/or refresh token, which may be encrypted using the public key. The encrypted authorization endpoint and/or refresh token are sent to the mobile authentication application 704, which may decrypt the information using the private key. The unencrypted authorization endpoint and/or refresh token are then stored on the mobile device for future use in using the mobile authentication application 704 to login to the website using a biometric input.

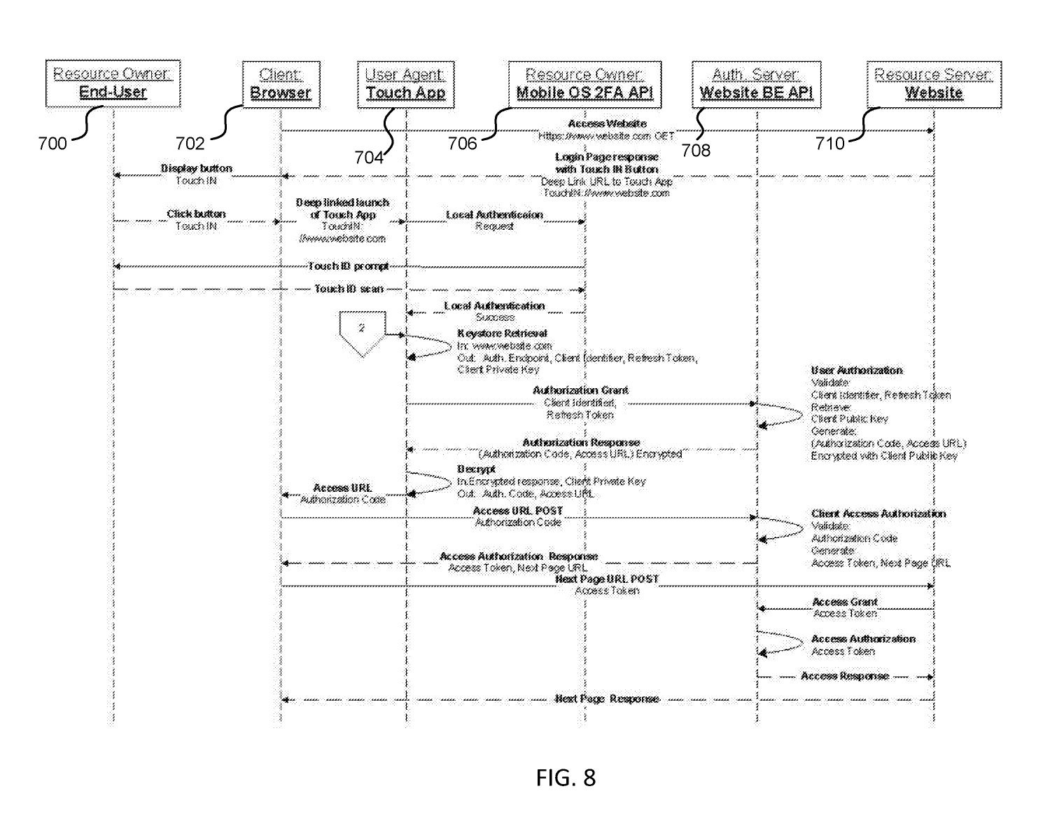

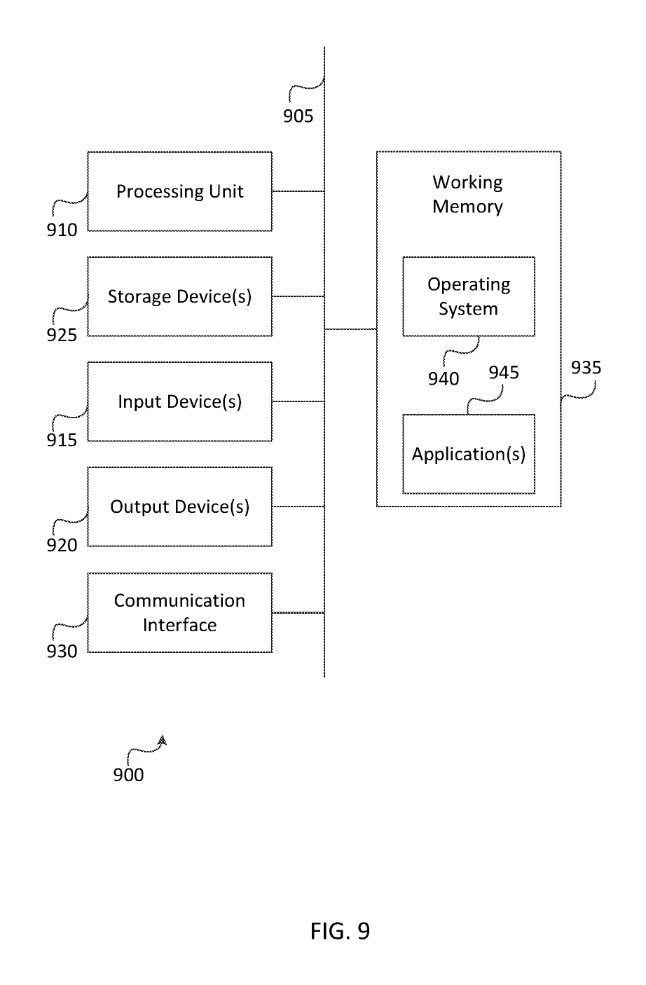

FIG. 8 is a swimlane diagram of a process for using a biometric input of user 700 to access the website. This process may be performed after a user has enrolled, using a process such as that described with regard to FIG. 7. For example, browser 702 may access the website hosted by remote server 710, which may provide a Touch In button including the “deep link” and URL to the browser 702 for display on the mobile device. The user 700 may click the Touch In button which causes the browser 702 to launch the mobile authentication application 704, as well as provide the URL to the mobile authentication application 704. The mobile authentication application 704 may send a local authentication request to the biometric mobile application 706, which may prompt the user 700 to provide a biometric input. The biometric mobile application 706 scans the biometric input provided by the user and upon successful authentication, provides an indication of successful authentication to the mobile authentication application 704.

Based on the website URL, the mobile authentication application 704 retrieves the authorization endpoint, browser identifier, refresh key, and/or private key associated with the URL from a memory of the mobile device. The mobile authentication application 704 then provides an indication of successful local authentication to the authorization server 708. The indication may include the browser identifier and the refresh token. The authorization server 708 may then validate the browser identifier and the refresh token before retrieving the public key. The authorization server 708 then generates an authorization code and access URL, which are encrypted with the public key and sent to the mobile authentication application 704. The mobile authentication application 704 decrypts the authorization code and access URL using the private key. The access URL and authorization code are provided to the browser 704, which in turn sends an authorization request to view a next page of the website to the authorization server 708. The request includes the access URL and the authorization code. The authorization server 708 then validates the authorization code and generates an access token and next page URL, which are provided to the browser 702. The browser 702 may then communicate the access token and next page URL to the resource server 710, which relays the access token to the authorization server 708. The authorization server 708 may authenticate the access token and submit a response authorizing the resource server 710 to provide the browser 702 with access to the next page URL.

A computer system as illustrated in FIG. 6 may be incorporated as part of the previously described computerized devices. For example, computer system 600 can represent some of the components of the servers 106 and 206, mobile devices 100 and 200, and/or ecommerce gateway 214 as described herein. FIG. 6 provides a schematic illustration of one embodiment of a computer system 600 that can perform the methods provided by various other embodiments, as described herein, and/or can function as a server, and ecommerce gateway, a mobile device, and/or other computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include a processing unit 610, including without limitation one or more specially programmed processors, such as one or more special-purpose processors (such as digital signal processing chips, graphics acceleration processors, application specific processors, and/or the like); one or more input devices 615, which can include without limitation a mouse, a keyboard, a touchscreen, receiver, a motion sensor, a camera, a smartcard reader, a contactless media reader, and/or the like; and one or more output devices 620, which can include without limitation a display device, a speaker, a printer, a writing module, and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communication interface 630, which can include without limitation a modem, a network card (wireless or wired), an infrared communication device, a wireless communication device and/or chipset (such as a Bluetooth™ device, an 502.11 device, a Wi-Fi device, a WiMax device, an NFC device, cellular communication facilities, etc.), and/or similar communication interfaces. The communication interface 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 610, applications 645, etc.) Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processing unit 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processing unit 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processing unit 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communication interface 630 (and/or the media by which the communication interface 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a non-transitory storage device 625 either before or after execution by the processing unit 610.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

What is claimed is:

1. A computing device configured for biometric authentication, the computing device comprising:
an input interface;
a biometric input interface comprising at least one biometric sensor;
a communications interface;
a memory; and
a processor, the processor configured to:
navigate a browser of the mobile device to a website;
receive, via the input interface, an input associated with a biometric access icon displayed on the website, the biometric access icon being associated with a secure webpage;
launch an interface of a mobile authentication application upon receiving the input, the interface comprising an instruction to provide a biometric input;
receive the biometric input using the biometric input interface of the computing device;
compare the received biometric input with a stored biometric input, the stored biometric input being stored on the memory of the computing device;
authenticate a user of the computing device based on the comparison of the received biometric input and the stored biometric input;
communicate, via the communications interface, an authentication confirmation to an entity associated with the secure webpage; and
receive, via the communications interface, a uniform resource locator (URL) associated with the secure webpage.

2. The method for validating a biometric input on a computing device of claim 1, wherein:
communicating the authentication confirmation to the entity comprises communicating the authentication confirmation to a backend server that routes the authentication confirmation to the entity;
the processor is further configured to:
authenticate the backend server using transport layer security (TLS) while the backend server authenticates the mobile authentication application such that the backend server trusts the authentication of the user by the mobile authentication application;
receive a single-use authorization code from the backend server; and
provide the single-use authorization code to the browser for provision to the backend server; and
the URL is received in response to the provision of the single-use authentication code to the backend server.

3. The method for validating a biometric input on a computing device of claim 1, wherein the processor is further configured to:
enroll the computing device for use with the biometric access icon.

4. The method for validating a biometric input on a mobile device of claim 1, wherein enrolling the computing device comprises:
displaying a prompt for user information associated with the secure webpage;
receiving the user information; and
sending the user information to a network storage device using a token service provider (TSP).

5. The method for validating a biometric input on a computing device of claim 1, wherein the processor is further configured to:
generate a cryptogram using the mobile authentication application upon successfully authenticating the user; and
provide the cryptogram to a backend server, wherein the cryptogram is validated as part of a multi-factor authentication process.

6. The method for validating a biometric input on a computing device of claim 1, wherein:
communicating the authentication confirmation to an entity comprises providing a browser identifier and a token to a backend server;
the processor is further configured to:
receive, using the mobile authentication application, an encrypted authorization code and an encrypted access URL from the backend server;
decrypt, using the mobile authentication application, the encrypted authorization code and the encrypted access URL using a private key;
provide the decrypted authorization code and the decrypted access URL to the browser;
send, using the browser, an authorization request to access the secure webpage, the authorization request comprising the decrypted authorization code and the decrypted access URL; and
receive, using the browser, an access token from the backend server, the access token being generated by the backend server in response to validating the decrypted authorization code; and
the URL associated with the secure webpage is received by the browser.

7. The method for validating a biometric input on a computing device of claim 6, wherein the processor is further configured to:
send, using the browser, the access token to the backend server;
receive an authorization message that provides the browser access to the secure webpage; and
navigating the browser to the secure webpage.

8. The method for validating a biometric input on a mobile device of claim 1, wherein:
the at least one biometric sensor comprises a fingerprint reader.

9. The method for validating a biometric input on a computing device of claim 1, wherein:
the secure webpage comprises a checkout confirmation webpage associated with the completion of a purchase transaction; and
the processor is further configured to, upon successful authentication, communicate transaction information associated with the purchase transaction to the entity associated with the secure webpage.

10. The method for validating a biometric input on a computing device of claim 9, wherein:
the interactive biometric access icon is embedded within a banner advertisement displayed on the website.

11. A method for validating a biometric input on a user device, the method comprising:
providing software code to a website, the software code causing an interactive biometric access icon to be displayed on devices accessing the website, the biometric access icon being associated with a secure webpage;
receiving an input from a user device, the input being indicative of an interaction with the interactive biometric access icon, the interaction causing an initialization of a biometric authentication application to execute on the user device;
receiving an indication that a user of the user device was successfully authenticated using the biometric authentication application;
retrieving user information associated with the authenticated user;
sending an authorization request to an entity associated with the secure webpage, the authorization request comprising the retrieved user information; and
receiving an authorization confirmation, the authorization confirmation comprising a uniform resource locator (URL) associated with the secure webpage.

12. The method for validating a biometric input on a user device of claim 11, further comprising:
enrolling the user device for use with the biometric access icon.

13. The method for validating a biometric input on a user device of claim 12, wherein:
enrolling the user device comprises:
prompting the user device for user information associated with the secure webpage;
receiving the user information from the user device; and
routing the user information and the URL associated with the secure webpage to a network storage device using a token service provider (TSP).

14. The method for validating a biometric input on a user device of claim 13, wherein:
retrieving user information comprises retrieving the user information from the network storage device.

15. The method for validating a biometric input on a user device of claim 11, further comprising:
issuing a token to the user device using a token service provider (TSP);
receiving a cryptogram upon receiving the indication that a user of the user device was successfully authenticated, wherein the cryptogram is generated by a token generator on the user device;
de-tokenizing the cryptogram using the TSP; and
validating the de-tokenized cryptogram using the TSP, wherein the authorization confirmation comprises an indication that the de-tokenized cryptogram was successfully validated.

16. The method for validating a biometric input on a user device of claim 11, further comprising:
authenticating the biometric authentication application using transport layer security (TLS);
communicating a single-use authorization code to the user device;
receiving the single-use authorization code from a browser of the user device; and
providing the URL associated with the secure webpage to the browser in response to receiving the single-use authentication code from the browser.

17. The method for validating a biometric input on a user device of claim 11, wherein:
receiving the indication that the user of the user device was successfully authenticated comprises receiving a browser identifier associated with the interactive biometric access icon and a token from the user device; and
the method further comprises:
validating the browser identifier and the token;
retrieving a public key upon validating the browser identifier and the token;
generating an authorization code and an access URL;
encrypting the authorization code and the access URL using the public key;
communicating the encrypted authorization code and the encrypted access URL to the biometric authentication application, wherein the biometric authentication application is configured to decrypt the encrypted authorization code and the encrypted access URL using a private key and to provide the decrypted authorization code and the decrypted access URL to a browser of the user device;
receiving an authorization request from the browser to access the secure webpage, the authorization request comprising the decrypted authorization code and the decrypted access URL;
validating the decrypted authorization code and the decrypted access URL;
generating an access token and retrieving the URL associated with the secure webpage in response to successfully validating the decrypted authorization code and the decrypted access URL; and
providing the access token and the URL associated with the secure webpage to the browser.

18. The method for validating a biometric input on a user device of claim 17, further comprising:
receiving the access token and the URL associated with the secure webpage from the browser;
authenticating the access token; and
authorizing the browser to access the URL associated with the secure webpage.

19. The method for validating a biometric input on a user device of claim 11, wherein:
the secure webpage comprises a checkout confirmation webpage associated with the completion of a purchase transaction; and
the method further comprises:
receiving transaction information associated with the purchase transaction; and
communicating the transaction information to the entity associated with the secure webpage.

20. The method for validating a biometric input on a user device of claim 19, wherein:
the interactive biometric access icon is embedded within a banner advertisement displayed on the website.
